(19) United States
(12) Patent Application Publication
(10) Pub. No.: US 2017/0168661 A1
(43) Pub. Date: Jun. 15, 2017

(54) METHOD FOR PLAYING MULTIPLE CHANNELS OF STREAMING MEDIA AND ELECTRONIC DEVICE

(71) Applicants: Le Holdings (Beijing) Co., Ltd., Beijing (CN); LE SHI INTERNET INFORMATION & TECHNOLOGY CORP., BEIJING

(72) Inventor: Xiang Qu, Beijing (CN)

(21) Appl. No.: 15/242,529

(22) Filed: Aug. 21, 2016

Related U.S. Application Data
(63) Continuation of application No. PCT/CN2016/089540, filed on Jul. 10, 2016.

(30) Foreign Application Priority Data
Dec. 15, 2015 (CN) 2015109378015

(51) Int. Cl. G06F 3/0481; H04L 29/06

(52) U.S. Cl. CPC G06F 3/0481; H04L 65/4069; H04L 65/604

(57) ABSTRACT

Embodiments of the present disclosure relate to the field of multimedia processing and disclose a method and device for playing multiple channels of streaming media and. The method includes: receiving at least two channels of streaming media from a streaming server through a network; sorting the at least two channels of streaming media in descending order of playing popularity; and playing streaming media that ranks first on a primary window of a display interface and outputting corresponding audio, and playing and muting each of remaining streaming media on a secondary window of a corresponding display interface. By means of the foregoing technical solutions, streaming media that ranks first is played on a primary window of a display interface and corresponding audio is output, and each of remaining streaming media is played and muted on a secondary window of a corresponding display interface, thereby effectively resolving a problem of crosstalk in a process of simultaneously playing multiple channels of streaming media.

### CROSS-REFERENCE TO RELATED APPLICATIONS

The present disclosure is a continuation of PCT application No. PCT/CN2016/089540 submitted on Jul. 10, 2016. The present disclosure claims priority to Chinese Patent Application No. 2015109378015, filed with the Chinese Patent Office on Dec. 15, 2015, and entitled “METHOD AND DEVICE FOR PLAYING MULTIPLE CHANNELS OF STREAMING MEDIA”, which is incorporated herein by reference in its entirety.

### TECHNICAL FIELD

The present disclosure relates to multimedia processing, and specifically, to a method for playing multiple channels of streaming media and an electronic device.

### BACKGROUND

With the popularization of internet, a requirement for transmitting a sound and video signal by using a network becomes increasingly larger. After such media as video broadcasting is accessed to the network, the media also expects to publish its own audio and video programs by means of internet. However, a size of a file of an audio video is usually excessively large when the audio video is stored. In a case of much limited network bandwidth, it is a matter of headache indeed to spend dozens of minutes or even loner time to wait transmission of an audio video file. Occurrence of streaming technologies improves a situation to some extents in which an audio video is difficult to be transmitted on the internet.

Streaming media refers to consecutive time-based media that uses streaming transmission technologies on the network, that is, media that real-time publishes content of such multimedia as audio and a video on the internet by means of a data stream. Audio, videos, animation or multimedia files of other forms all belong to the streaming media.

Streaming media is a multimedia file in which under supports of streaming technologies, consecutive image and sound information are uploaded on a network server after being compressed, so that a browser downloads the file while viewing or listening to the file, and can view the file real-time and does not need to wait until the whole multimedia file is downloaded. To some extents, streaming technologies overcome a limit of network bandwidth to multimedia information transmission, and therefore, it is widely applied to multiple fields, for example, network live broadcasting, network advertising, videos on-demand, distance learning, Tele Medicine, video conference, enterprise training and e-commerce.

Continuous improvements of the network bandwidth enable multiple channels of streaming media, and in a scenario of multiple channels of streaming media, one piece of user equipment may simultaneously obtain at least two channels of streaming media for playing from a network streaming server. Because in general cases, one piece of user equipment has only one loudspeaker, and therefore, it is a problem to be resolved immediately that sound of which streaming media is determined to be played in a scenario of multiple channels of streaming media.

For the foregoing problems, there is still no good solution in the prior art.

### SUMMARY

Objectives of some embodiments of the present invention are to provide a method and a device which enable multiple channels of streaming media to be played on demand.

According to a first aspect, the present disclosure provides a method for playing multiple channels of streaming media, including: receiving at least two channels of streaming media from a streaming server through a network; sorting the at least two channels of streaming media in descending order of playing popularity; and playing streaming media that ranks first on a primary window of a display interface and outputting corresponding audio, and playing and muting each of remaining streaming media on a secondary window of a corresponding display interface.

According to a second aspect, some embodiments of this disclosure provides a non-volatile computer storage medium, which stores computer executable instructions, where the computer executable instructions are used to execute any foregoing method for playing multiple channels of streaming media of this disclosure.

According to a third aspect, some embodiments of this disclosure further provides an electronic device, including: at least one processor; and a memory. The memory stores instructions that can be executed by the at least one processor, and the instructions are executed by the at least one processor, so that the at least one processor can execute any foregoing method for playing multiple channels of streaming media of this disclosure.

Other characteristics and advantages of the present disclosure are described in detail in the following part of descriptions of specific examples.

### BRIEF DESCRIPTION OF THE DRAWINGS

One or more embodiments are exemplarily described by using figures that are corresponding thereto in the accompanying drawings; the exemplary descriptions do not form a limitation to the embodiments. Elements with same reference signs in the accompanying drawings are similar elements. Unless otherwise particularly stated, the figures in the accompanying drawings do not form a scale limitation.

FIG. 1 is a flowchart of a method for playing multiple channels of streaming media according to the present disclosure; and

FIG. 2 is a schematic structural diagram of hardware of a device for executing a method for playing multiple channels of streaming media according to this disclosure.

### DETAILED DESCRIPTION

Specific examples of the present disclosure are described in detail with reference to accompanying drawings in the following. It should be understood that the specific examples described herein are only used to specify and explain the present disclosure and not used to limit the present disclosure.

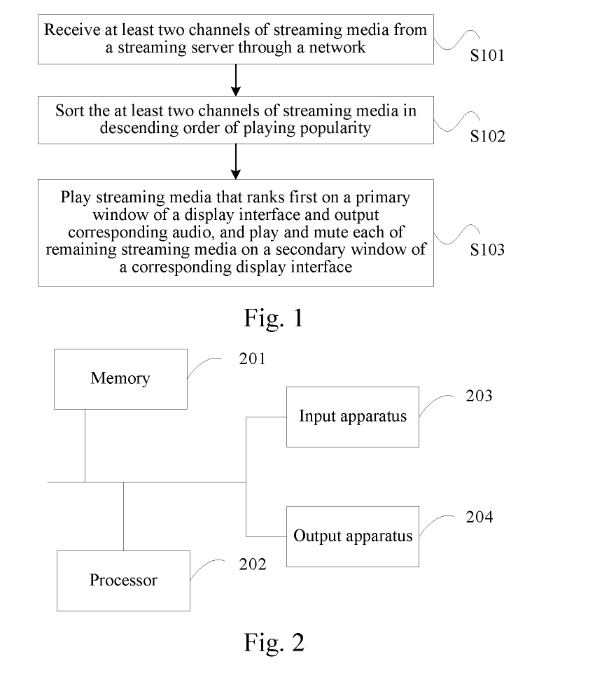

FIG. 1 is a flowchart of a method for playing multiple channels of streaming media according to an example of the present disclosure. As shown in FIG. 1, the present disclosure provides a method for playing multiple channels of streaming media, where the method may include: S101, receiving at least two channels of streaming media from a streaming server through a network; S102, sorting the at least two channels of streaming media in descending order of playing popularity; and S103, playing streaming media that ranks first on a primary window of a display interface and outputting corresponding audio, and playing and muting each of remaining streaming media on a secondary window of a corresponding display interface.

The method provided by the present disclosure may be applicable to a terminal playing the streaming media. A terminal used as an example or a terminal for playing a video may be a device having a display/screen, for example, a television, a tablet computer, and a smartphone. The terminal may have a wired and/or wireless networking capability, so that the terminal can be in communication with a streaming server configured to provide the streaming media through a network, and obtain (for example, at least two channels of) streaming media from the streaming server. The terminal used as an example may include a processor, where the processor may be a multi-core processor or may have a multi-process capability, capable of simultaneously decoding and playing multiple channels of streaming media.

In an example, the playing popularity is the number of times the streaming media is played on demand or the number of web searches for the streaming media. Selection of the playing popularity may be based on collected statistics, for example, the number of web searches for content within a given time (for example, a week) is sorted to determine playing popularity of each of the streaming media in the order. Afterwards, when the terminal requests to play the multiple channels of streaming media, the selected streaming media is performed playing popularity sorting (for example, from high to low) according to the playing popularity, and the multiple channels of streaming media are distributed for playing on the primary window and the secondary window preset at fixed positions of the display interface according to a sorting result. In an example, to avoid crosstalk or audio mixing, in playing, audio of the streaming media only played on the primary window is sent to a loudspeaker of the terminal for outputting, and the streaming media played on the secondary window is muted.

In an example, a user of the terminal may set the streaming media played on the primary window by means of a window operation. In the example, the terminal may have an input apparatus, for example, a keyboard, and a touchscreen. In an example, when the streaming media played on a secondary window is selected by the input apparatus, the terminal may set the selected streaming media as streaming media that the user is interested in and expects to hear its sound, and play the selected streaming media on the primary window and output corresponding audio. For the streaming media previously played on the primary window, according to operation logic, at this time the streaming media is not the streaming media that the user is interested in, and the streaming media may end in playing or be muted. In an example, the streaming media previously played on the primary window may be switched to the secondary window for playing and muting.

In another example, when the user selects the streaming media that he expects to hear its sound, the streaming media on the primary window and the secondary window may not be exchanged, and playing windows of the two pieces of streaming media may be reserved and only audio status of the streaming media may be changed. For example, when streaming media played on a secondary window is selected, audio corresponding to the streaming media may be output, and the streaming media played on the primary window may be muted.

The foregoing method provided by the present disclosure may be implemented by using a device for playing multiple channels of streaming media. The device for playing multiple channels of streaming media and used as an example may have a display/screen, a wireless transceiver unit, a memory, a processor, a loudspeaker, and an input unit. The display/screen is configured to display content of streaming media played; the wireless transceiver unit may be configured to provide a communication connection between a device for playing multiple channels of streaming media and a streaming server; the memory may be configured to: cache streaming media from the streaming server and store executable instructions that execute the method for playing multiple channels of streaming media described in the example of the present disclosure; the processor may be configured to: decode and play streaming media and control working of components of the display/screen, the wireless transceiver unit, and the loudspeaker; and the input unit may be configured to receive an operation of the user.

Another aspect of the present disclosure provides a device for playing multiple channels of streaming media, including: an apparatus, configured to receive at least two channels of streaming media from a streaming server through a network; an apparatus, configured to sort the at least two channels of streaming media in descending order of playing popularity; and an apparatus, configured to: play streaming media that ranks first on a primary window of a display interface and output corresponding audio, and play and mute each of remaining streaming media on a secondary window of a corresponding display interface.

In an example, the device may further include: an apparatus, configured to: when streaming media played on a secondary window is selected, play the selected streaming media on the primary window and output corresponding audio; and an apparatus, configured to switch the streaming media previously played on the primary window to the secondary window for playing and muting.

In an example, the device may further include: an apparatus, configured to: when streaming media played on a secondary window is selected, output audio corresponding to the streaming media, and mute the streaming media played on the primary window.

In an example, the device may further include: an apparatus, configured to preset the primary window and the secondary window at fixed positions on the display interface. In an example, the playing popularity is the number of times the streaming media is played on demand or the number of web searches for the streaming media.

According to the foregoing technical solutions, streaming media that ranks first is played on a primary window of a display interface and corresponding audio is output, and each of remaining streaming media is played and muted on a secondary window of a corresponding display interface, thereby effectively resolving a problem of crosstalk in a process of simultaneously playing multiple channels of streaming media.

This disclosure further provides a non-volatile computer storage medium, which stores computer executable instructions, where the computer executable instructions can execute the method for playing multiple channels of streaming media in any one of the foregoing method embodiments.

FIG. 2 is a schematic structural diagram of hardware of a device for executing a method for playing multiple channels of streaming media provided in this disclosure. As shown in FIG. 2, the device includes:

one or more processors 202 and a memory 201, where only one processor 202 is used as an example in FIG. 2.

A device for executing the method for playing multiple channels of streaming media may further include: an input apparatus 203 and an output apparatus 204.

The processor 202, the memory 201, the input apparatus 203, and the output apparatus 204 can be connected by means of a bus or in other manners. A connection by means of a bus is used as an example in FIG. 2.

As a non-volatile computer readable storage medium, the memory 201 can be used to store non-volatile software programs, non-volatile computer executable programs and modules, for example, program instructions/module corresponding to the method for playing multiple channels of streaming media in the embodiments of this disclosure. The processor 202 executes various functional applications and data processing of the server, that is, implements the method for playing multiple channels of streaming media of the foregoing method embodiments, by running the non-volatile software programs, instructions, and modules that are stored in the memory 201.

The memory 201 may include a program storage area and a data storage area, where the program storage area may store an operating system and an application that is needed by at least one function; the data storage area may store data created according to use of the server, and the like. In addition, the memory 201 may include a high-speed random access memory, or may also include a non-volatile memory such as at least one disk storage device, flash storage device, or another non-volatile solid-state storage device. In some embodiments, the memory 201 optionally includes memories that are remotely disposed with respect to the processor 202, and the remote memories may be connected, via a network, to the server. Examples of the foregoing network include but are not limited to: the Internet, an intranet, a local area network, a mobile communications network, or a combination thereof.

The input apparatus 203 can receive entered digits or character information, and generate key signal inputs relevant to user setting and functional control of the server. The output apparatus 204 may include a display device, for example, a display screen.

The one or more modules are stored in the memory 201; when the one or more modules are executed by the one or more processors 202, the method for playing multiple channels of streaming media in any one of the foregoing method embodiments is executed.

The foregoing product can execute the method provided in the embodiments of this disclosure, and has corresponding functional modules for executing the method and beneficial effects. Refer to the method provided in the embodiments of this disclosure for technical details that are not described in detail in some embodiments.

The electronic device in some embodiments of this disclosure exists in multiple forms, including but not limited to:

(1) Mobile communication device: such devices are characterized by having a mobile communication function, and primarily providing voice and data communications; terminals of this type include: a smart phone (for example, an iPhone), a multimedia mobile phone, a feature phone, a low-end mobile phone, and the like;

(2) Ultra mobile personal computer device: such devices are essentially personal computers, which have computing and processing functions, and generally have the function of mobile Internet access; terminals of this type include: PDA, MID and UMPC devices, and the like, for example, an iPad;

(3) Portable entertainment device: such devices can display and play multimedia content; devices of this type include: an audio and video player (for example, an iPod), a handheld game console, an e-book, an intelligent toy and a portable vehicle-mounted navigation device;

(4) Server: a device that provides a computing service; a server includes a processor, a hard disk, a memory, a system bus, and the like; an architecture of a server is similar to a universal computer architecture. However, because a server needs to provide highly reliable services, requirements for the server are high in aspects of the processing capability, stability, reliability, security, extensibility, and manageability; and

(5) other electronic apparatuses having a data interaction function.

The apparatus embodiment described above is merely exemplary, and units described as separated components may be or may not be physically separated; components presented as units may be or may not be physical units, that is, the components may be located in a same place, or may be also distributed on multiple network units. Some or all modules therein may be selected according to an actual requirement to achieve the objective of the solution of some embodiments.

Through description of the foregoing implementation manners, a person skilled in the art can clearly learn that each implementation manner can be implemented by means of software in combination with a universal hardware platform, and certainly, can be also implemented by using hardware. Based on such understanding, the essence, or in other words, a part that makes contributions to relevant technologies, of the foregoing technical solutions can be embodied in the form of a software product. The computer software product may be stored in a computer readable storage medium, for example, a ROM/RAM, a magnetic disk, or a compact disc, including several instructions for enabling a computer device (which may be a personal computer, a sever, or a network device, and the like) to execute the method in the embodiments or in some parts of the embodiments.

Finally, it should be noted that: the foregoing embodiments are only used to describe the technical solutions of this disclosure, rather than limit this disclosure. Although this disclosure is described in detail with reference to the foregoing embodiments, a person of ordinary skill in the art should understand that he/she can still modify technical solutions disclosed in the foregoing embodiments, or make equivalent replacements to some technical features therein; however, the modifications or replacements do not make the essence of corresponding technical solutions depart from the spirit and scope of the technical solutions of the embodiments of this disclosure.

Although an example of the present disclosure has been described in detail above with reference to the accompanying drawings, the present disclosure is not limited to specific details in the foregoing example. Various simple variations can be made to the technical solutions of the present disclosure within the scope of the technical idea of the present disclosure, and such simple variations all fall within the protection scope of the present disclosure.

It should be further noted that the specific technical features described in the foregoing specific examples can be combined in any appropriate manner as long as no conflict occurs. To avoid unnecessary repetition, various possible combination manners will not be described in the present disclosure.

In addition, various different examples of the present disclosure may also be combined arbitrarily. Such combinations shall also be considered as the content disclosed by the present disclosure as long as these combinations do not depart from the concept of the present disclosure.

What is claimed is:

1. A method for playing multiple channels of streaming media, applied to a terminal, comprising:
receiving at least two channels of streaming media from a streaming server through a network;
sorting the at least two channels of streaming media in descending order of playing popularity; and
playing streaming media that ranks first on a primary window of a display interface and outputting corresponding audio, and playing and muting each of remaining streaming media on a secondary window of a corresponding display interface.

2. The method according to claim 1, further comprising:
when streaming media played on a secondary window is selected, playing the selected streaming media on the primary window and outputting corresponding audio; and
switching the streaming media previously played on the primary window to the secondary window for playing and muting.

3. The method according to claim 1, further comprising:
when streaming media played on a secondary window is selected, outputting audio corresponding to the streaming media, and muting the streaming media played on the primary window.

4. The method according to claim 1, further comprising:
presetting the primary window and the secondary window at fixed positions on the display interface.

5. The method according to claim 2, further comprising:
presetting the primary window and the secondary window at fixed positions on the display interface.

6. The method according to claim 3, further comprising:
presetting the primary window and the secondary window at fixed positions on the display interface 7.

7. The method according to claim 1, wherein the playing popularity is the number of times the streaming media is played on demand or the number of web searches for the streaming media.

8. The method according to claim 2, wherein the playing popularity is the number of times the streaming media is played on demand or the number of web searches for the streaming media.

9. The method according to claim 3, wherein the playing popularity is the number of times the streaming media is played on demand or the number of web searches for the streaming media.

10. The method according to claim 4, wherein the playing popularity is the number of times the streaming media is played on demand or the number of web searches for the streaming media.

11. A non-volatile computer storage medium storing executable instructions that, when executed by a computer, cause the computer to:
receive at least two channels of streaming media from a streaming server through a network;
sort the at least two channels of streaming media in descending order of playing popularity; and
play streaming media that ranks first on a primary window of a display interface and output corresponding audio, and play and mute each of remaining streaming media on a secondary window of a corresponding display interface.

12. The non-volatile computer storage medium according to claim 11, wherein the executable instructions are further configured to:
when streaming media played on a secondary window is selected, play the selected streaming media on the primary window and output corresponding audio; and
switch the streaming media previously played on the primary window to the secondary window for playing and muting.

13. The non-volatile computer storage medium according to claim 11, wherein the executable instructions are further configured to:
when streaming media played on a secondary window is selected, output audio corresponding to the streaming media, and mute the streaming media played on the primary window.

14. The non-volatile computer storage medium according to claim 11, wherein the executable instructions are further configured to:preset the primary window and the secondary window at fixed positions on the display interface.

15. The non-volatile computer storage medium according to claim 11, wherein the playing popularity is the number of times the streaming media is played on demand or the number of web searches for the streaming media.

16. An electronic device, comprising:
at least one processor; and
a memory communicably connected with the at least one processor for storing instructions executable by the at least one processor,
wherein execution of the instructions by the at least one processor causes the at least one processor to:
receive at least two channels of streaming media from a streaming server through a network;
sort the at least two channels of streaming media in descending order of playing popularity; and
play streaming media that ranks first on a primary window of a display interface and output corresponding audio, and play and mute each of remaining streaming media on a secondary window of a corresponding display interface.

17. The electronic device according to claim 16, the instructions are further configured to:
when streaming media played on a secondary window is selected, play the selected streaming media on the primary window and outputting corresponding audio; and
switch the streaming media previously played on the primary window to the secondary window for playing and muting.

18. The electronic device according to claim 16, the instructions are further configured to:
when streaming media played on a secondary window is selected, output audio corresponding to the streaming media, and mute the streaming media played on the primary window.

19. The electronic device according to claim 16, the instructions are further configured to:
preset the primary window and the secondary window at fixed positions on the display interface.

20. The electronic device according to claim 16, wherein the playing popularity is the number of times the streaming media is played on demand or the number of web searches for the streaming media.
